(19) United States
(12) Patent Application Publication
(10) Pub. No.: US 2015/0163233 A1
(43) Pub. Date: Jun. 11, 2015

(54) Method And Apparatus For Scanning Files

(71) Applicant: TENCENT TECHNOLOGY (SHENZHEN) COMPANY LIMITED, Shenzhen City (CN)

(72) Inventor: Guize LIU, Shenzhen (CN)

(21) Appl. No.: 14/624,608

(22) Filed: Feb. 18, 2015

Related U.S. Application Data
(63) Continuation of application No. PCT/CN2013/082271, filed on Aug. 26, 2013.

(30) Foreign Application Priority Data
Sep. 27, 2012 (CN) 201210374390.X

(51) Int. Cl. H04L 29/06

(52) U.S. Cl. CPC H04L 63/145

(57) ABSTRACT

A method and apparatus for scanning files are provided. The method includes determining whether to perform a full scanning according to a pre-scanning mode. The method further includes determining whether a deep scanning is selected by a user, when it is determined not to perform the full scanning according to the pre-scanning mode. The method further includes performing the deep scanning, when the deep scanning is selected by the user.

### CROSS-REFERENCE TO RELATED APPLICATIONS

This application is a continuation of International Patent Application No. PCT/CN2013/082271, filed on Aug. 26, 2013. This application claims the benefit and priority of Chinese Application No. 201210374390.X, filed Sep. 27, 2012. The entire disclosures of each of the above applications are incorporated herein by reference.

### FIELD

The present disclosure relates to a method and apparatus for scanning files.

### BACKGROUND

This section provides background information related to the present disclosure which is not necessarily prior art.

Trojans are always hidden in some critical paths of a system to damage the normal running of the system and steal user information. Most Trojans also register as a self-starting program, so as to get a running opportunity as soon as possible after the system starts running. In addition, some stubborn Trojans not only release malicious files under critical directories, they may even infect all programs on the system. As long as one infected program is not removed, the entire system will face the risk of being controlled by the Trojans.

Currently, the two most commonly used scanning methods include quick scanning and full scanning. The quick scanning is the most widely used scanning method. In the quick scanning, critical directory files, self-starting register entries, self-starting programs, system memory environment, and on the like are scanned and tested to identify conventional popular Trojans. In the full scanning, all files on the hard disk are scanned, e.g. programs, documents, and archives are scanned to identify the maximum number of Trojans that exist on the system.

However, in the quick scanning, only files and programs at sensitive locations of the system are scanned and tested. When the Trojan is hidden in non-sensitive positions or when the Trojans release malicious files at both sensitive and non-sensitive locations, the Trojans cannot be removed completely. In full scanning, all files and programs of the system are scanned, the number of which may range from tens of thousands to hundreds of thousands, and thus, the scanning time is very long. Additionally, during this time period, most of the system resources such as the memory, disk I/O, CPU, etc. are occupied by the scanning process, and the response sensitivity of other programs is seriously affected.

Hence, scanning efficiency of the conventional scanning methods is relatively low.

### SUMMARY

This section provides a general summary of the disclosure, and is not a comprehensive disclosure of its full scope or all of its features.

Various embodiments of the present disclosure provide a method and apparatus for scanning files, so that a scanning mode of a system is selected intelligently according to a security state of the system, and scanning efficiency is improved.

A method for scanning files includes:

determining whether to perform a full scanning according to a pre-scanning mode;

determining whether a deep scanning is selected by a user, when it is determined not to perform the full scanning according to the pre-scanning mode; and

performing the deep scanning, when the deep scanning is selected by the user.

An apparatus for scanning files includes:

a pre-scanning unit to determine whether to perform a full scanning according to a pre-scanning mode;

a determining unit, to determine whether a deep scanning is selected by a user, when it is determined not to perform the full scanning according to the pre-scanning mode; and

a deep scanning unit, to perform the deep scanning, when the deep scanning is selected by the user.

According to the present disclosure, before the scanning operation is started, whether to perform the full scanning is determined according to the pre-scanning mode. When the full scanning is not required, the scanning is performed according to the selection of the user. Therefore, the scanning mode is selected intelligently according the security state of the system on the terminal device, and thus, the scanning efficiency is improved.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for scanning files according to various embodiments of the present disclosure;

FIG. 2 is a flowchart illustrating a method for scanning files according to various embodiments of the present disclosure;

FIG. 3 is a diagram illustrating a structure of an apparatus for scanning files according to various embodiments of the present disclosure; and

FIG. 4 is a diagram illustrating a structure of a pre-scanning unit of a terminal device for scanning files according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

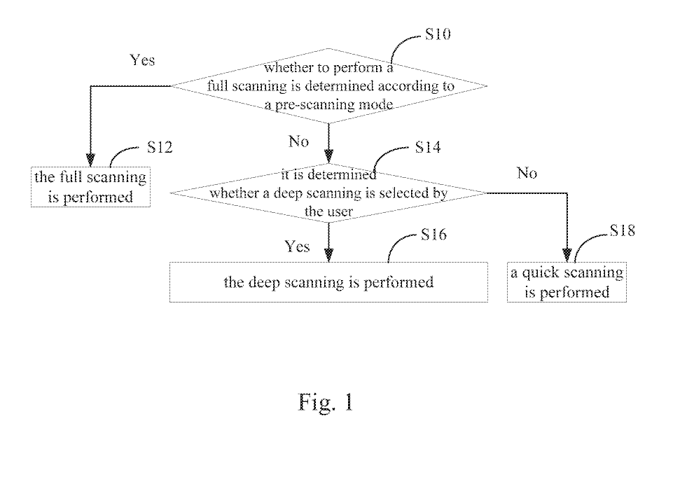

The description will be made as to the various embodiments in conjunction with the accompanying drawings in FIGS. 1-4. It should be understood that specific embodiments described herein are merely intended to explain the present disclosure, but not intended to limit the present disclosure. In accordance with the purposes of this disclosure, as embodied and broadly described herein, this disclosure, in one aspect, relates to method and apparatus for scanning files.

Examples of mobile terminals that can be used in accordance with various embodiments include, but are not limited to, a tablet PC (including, but not limited to, an Apple iPad and other touch-screen devices running Apple iOS, a Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, an Amazon Kindle and a Barnes & Noble Nook), a laptop computer (including, but not limited to, computers running an Apple Mac operating system, a Windows operating system, an Android operating system and/or Google Chrome operating system), or an on-vehicle device running any of the above-mentioned operating systems or any other operating systems, all of which are well known to one skilled in the art.

FIG. 1 is a flowchart illustrating a method for scanning files according to various embodiments of the present disclosure. According to various embodiments, before starting to scan system files and stored files on a hard disk, a terminal device makes a prejudgment for the system files and stored files on the hard disk, so as to determine subsequent scanning processes. In the various embodiments, the terminal device may be a personal computer (PC), a tablet PC, or a mobile phone.

At S10, whether to perform a full scanning is determined according to a pre-scanning mode. According to various embodiments, in the pre-scanning mode, a current system state of the terminal device is diagnosed according to a preset determining policy. The preset determining policy includes: testing sensitive locations of the system by using an experience rule library to determine whether there is a Trojan characteristic of infecting all programs on a hard disk, and/or quickly testing storage directories of application software to determine whether there is a Trojan characteristic indicating a system Dynamic Link Library (DLL) is hijacked and/or, determining whether there is prior characteristic of full scanning.

In the various embodiments, when there is no Trojan characteristic of infecting all programs on the hard disk, when there is no Trojan characteristic indicating the system DLL is hijacked, and when there is no prior characteristic of full scanning, it is indicated that security state of the system is normal and the full scanning is not performed. When there is the Trojan characteristic of infecting all programs on the hard disk, or when there is the Trojan characteristic indicating the system DLL is hijacked, or when there is the prior characteristic of full scanning, it is indicated that security state of the system is abnormal and the full scanning is performed.

When it is determined to perform the full scanning according to the pre-scanning mode, processing at S12 is performed; when it is determined not to perform the full scanning according to the pre-scanning mode, processing at S14 is performed.

At S12, the full scanning is performed. According to various embodiments, in the full scanning, all files on the hard disk of the system, i.e. programs, documents, and archives, are scanned, so as to identify the maximum number of Trojans that exist on the system.

At S14, it is determined whether a deep scanning is selected by the user. According to various embodiments, scanning scopes of the deep scanning include system critical locations of the quick scanning, a path backtracking of a system active process, and a path backtracking of a software uninstall item. The path backtracking refers to when an original path is C:\program files\tencent\qq\bin\qq.exe, the backtracking path is c:\program files\tencent. The above scanning scopes basically cover all locations of program files of the system, so as to avoid scanning a large number of non-program directories and personal file directories, and thus, scanning performance is improved.

According to various embodiments, the terminal device may prompt the user to select the deep scanning by using a display mode. When the user selects the deep scanning, the terminal device may determine that the deep scanning is selected by the user.

When the user selects the deep scanning, processing at S16 is performed; when the user does not select the deep scanning, processing at S18 is performed.

At S16, the deep scanning is performed. According to various embodiments, the terminal device may scan the following scopes: system critical locations of the quick scanning, a path backtracking of a system active process and a path backtracking of a software uninstall item. The scanning scopes of the deep scanning basically cover all locations of program files of the system. Compared with quick scanning, more hidden Trojans are found by using a longer scanning time, and compared with the full scanning, time-consuming is shortened significantly and the number of occupied resources is reduced.

At S18, a quick scanning is performed. When the user does not select the deep scanning, the terminal device determines that the quick scanning is to be performed. In the quick scanning, critical system directory files, self-starting register entries, self-starting programs, system memory environment and etc. are scanned and tested to identify conventional popular Trojans.

In various embodiments of the present disclosure, before the scanning operation is started, the security state of the system is predetermined by using the pre-scanning mode. When the security state is bad, the full scanning is performed to test the Trojans thoroughly. When the security state is good, the quick scanning may be performed to consume few resources, or the deep scanning may be performed to find more hidden Trojans.

Further, in the various embodiments of the present disclosure, before the scanning operation is started, whether to perform the full scanning is determined according to the pre-scanning mode. When the full scanning is not required, the scanning is performed according to the selection of the user. Therefore, the scanning mode is selected intelligently according to the security state of the system on the terminal device, and thus the scanning efficiency is improved.

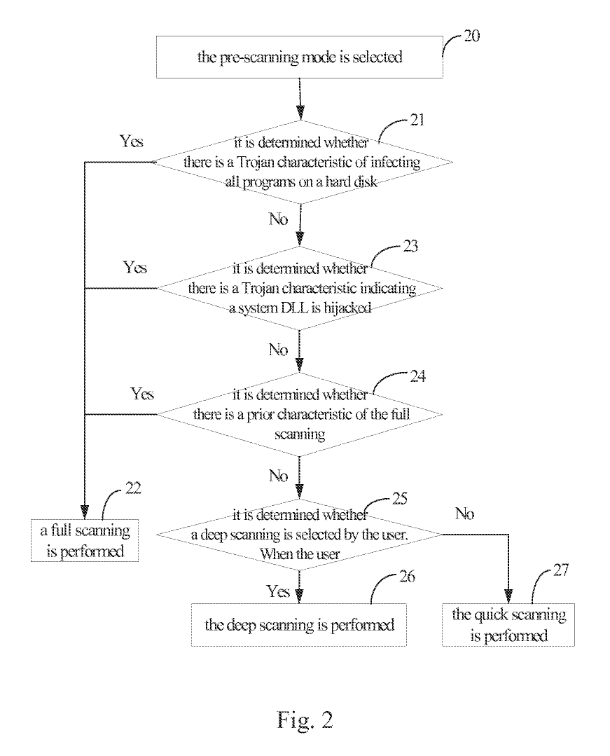

FIG. 2 is a flowchart illustrating a method for scanning files according to various embodiments of the present disclosure.

According to various embodiments, before starting to scan system files and stored files on a hard disk, a terminal device makes a prejudgment for the system files and stored files on the hard disk, so as to determine subsequent scanning processes. According to various embodiments, a pre-scanning mode may be selected by a user of the terminal device, or when the user triggers a scanning function, the terminal device performs scanning processing according to the pre-scanning mode by default, and then another scanning mode may be selected.

At S20, the pre-scanning mode is selected.

At S21, it is determined whether there is a Trojan characteristic of infecting all programs on a hard disk. When there is the Trojan characteristic of infecting all programs on the hard disk, it is indicated that a security state of a system on the terminal device is abnormal, and processing at S22 is performed. When there is no Trojan characteristic of infecting all programs on the hard disk, processing at S23 is performed. The Trojan characteristic of infecting all programs on the hard disk at least includes: an exe disguised as a folder, that is, the name of the exe is the same as the name of the folder under the same directory, and the icon of the exe is an icon of the folder.

At S22, a full scanning is performed. In the full scanning, all files on the hard disk of the system, i.e. programs, documents, archives, are scanned, so as to identify the maximum Trojans exist on the system.

At S23, it is determined whether there is a Trojan characteristic indicating a system DLL is hijacked. When there is the Trojan characteristic indicating the system DLL is hijacked, it is indicated that the security state of the system on the terminal device is abnormal, and processing at S22 is performed; when there is no Trojan characteristic indicating the system DLL is hijacked, processing at S24 is performed.

According to various embodiments, when the system DLL is hijacked, the Trojan releases a file under an install directory of each piece of software and the name of the file is the same as a system DLL, e.g. usp10.dll, Ipk.dll and etc. In this way, when a program is running, the file released by the Trojan rather than the normal system DLL is loaded, and thus the Trojan is loaded by all programs of the system. Therefore, when there is the Trojan characteristic indicating the system DLL is hijacked, the full scanning is needed.

At S24, it is determined whether there is a prior characteristic of the full scanning. When there is the prior characteristic of the full scanning, it is indicated that the security state of the system on the terminal device is abnormal, and the processing at S22 is performed; when there is no prior characteristic of the full scanning, it is indicated that the security state of the system on the terminal device is normal after the above three are determined, and processing at S25 is performed.

According to various embodiments, the prior characteristic may be a new Trojan characteristic that will infect all programs on the hard disk, and the prior characteristic may be found by using sample collection operations or by receiving information from users. The prior characteristic needs continued maintenance. For example, the prior characteristic may be a virus of an infection type, and this virus will infect all EXEs of the system.

It should be noted that a sequence of performing the processing at S21, S23, and S24 is not limited according to examples of the present disclosure. For example, the processing at S23 may be performed first; when there is no Trojan characteristic indicating the system DLL is hijacked, the processing at S21 may be performed; when there is no Trojan characteristic of infecting all programs on the hard disk, processing at S24 may be performed; and finally, when there is no prior characteristic of the full scanning, the processing at S25 is performed.

At S25, it is determined whether a deep scanning is selected by the user. When the user selects the deep scanning, processing at S26 is performed; when the user does not select the deep scanning, processing at S27 is performed. According to various embodiments, the terminal device may prompt the user to select the deep scanning by using a display mode. When the user selects the deep scanning, the terminal device may determine that the deep scanning is selected by the user. When the user does not select the deep scanning, the terminal device may perform the quick scanning by default.

At S26, the deep scanning is performed. The deep scanning is a scanning mode between the full scanning and the quick scanning. In addition to the system critical locations being scanned, directories of all executable program of the system are scanned, and non-program directories, i.e. documents, pictures and multimedia are not scanned, and thus scanning time is saved.

According to various embodiments, scanning scopes of the deep scanning include system critical locations of the quick scanning, a path backtracking of a system active process, and a path backtracking of a software uninstall item. The path backtracking, refers to when an original path is C:\program files\tencent\qq\bin\qq.exe, the backtracking path is c:\program files\tencent. The above scanning scopes basically cover all locations of program files of the system, so as to avoid scanning a large number of non-program directories and personal file directories, and thus, scanning performance is improved.

At S27, the quick scanning is performed. When the user does not select the deep scanning, the terminal device may perform the quick scanning by default. In the quick scanning, critical system directory files, self-starting register entries, self-starting programs, system memory environment, etc. are scanned and tested to identify conventional popular Trojans.

By using the technical solutions provided by the various embodiments of the present disclosure, before the scanning operation is started, the security state of the system is predetermined by using the pre-scanning mode. When the security state is bad, the full scanning is performed to test the Trojans thoroughly. When the security state is good, the quick scanning may be performed to consume few resources, or the deep scanning may be performed to find more hidden Trojans.

Further, by using the technical solutions provided by the various embodiments of the present disclosure, before the scanning operation is started, whether to perform the full scanning is determined according to the pre-scanning mode. When the full scanning is not required, the scanning is performed according to the selection of the user. Therefore, the scanning mode is selected intelligently according to the security state of the system on the terminal device, and thus, the scanning efficiency is improved.

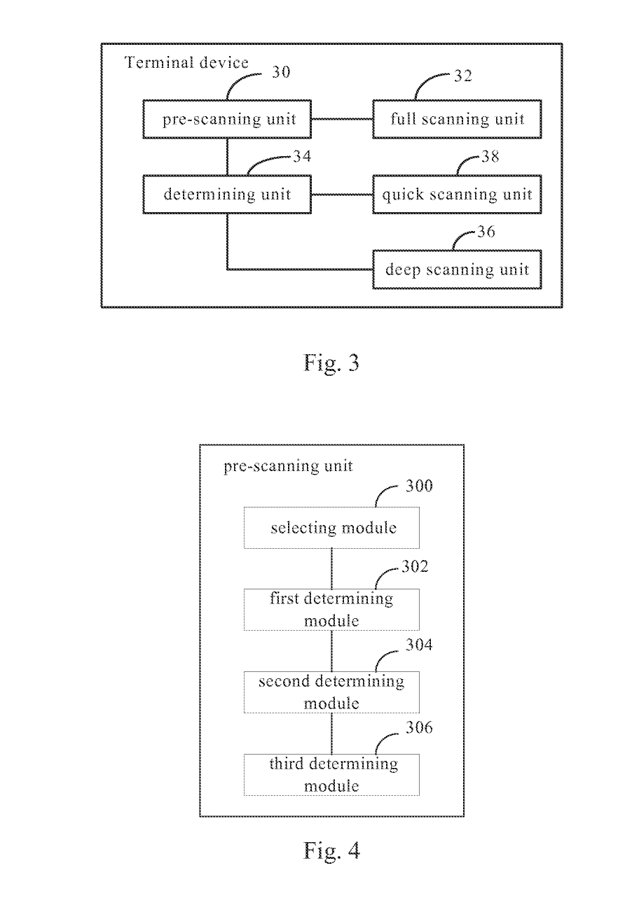

FIG. 3 is a diagram illustrating a structure of an apparatus for scanning files according to various embodiments of the present disclosure. As shown in FIG. 3, the apparatus includes a pre-scanning unit 30, a full scanning unit 32, a determining unit 34, a quick scanning unit 38, and a deep scanning unit 36. In the various embodiments, the apparatus may be a terminal device, such as a personal computer or a mobile terminal, e.g. a tablet PC or a mobile phone. According to various embodiments, the pre-scanning unit 30 is to determine whether to perform a full scanning according to a pre-scanning mode.

According to various embodiments, in the pre-scanning mode, a current system state of the terminal device is diagnosed according to a preset determining policy. The preset determining policy includes: testing sensitive locations of the system by using an experience rule library to determine whether there is a Trojan characteristic of infecting all programs on a hard disk and/or quickly testing storage directories of application software to determine whether there is a Trojan characteristic indicating a system DLL is hijacked, and/or, determining whether there is a prior characteristic of full scanning.

In the various embodiments, when there is no Trojan characteristic of infecting all programs on the hard disk, when there is no Trojan characteristic indicating the system DLL is hijacked, and when there is no prior characteristic of full scanning, it is indicated that security state of the system is normal and the full scanning is not performed. When there is the Trojan characteristic of infecting all programs on the hard disk, or when there is the Trojan characteristic indicating the system DLL is hijacked, or when there is the prior characteristic of full scanning, it is indicated that security state of the system is abnormal and the full scanning is performed.

The full scanning unit 32 performs the full scanning when the pre-scanning unit 30 determines whether to perform the full scanning according to the pre-scanning mode. In the full scanning performed by the full scanning unit 32, all files on the hard disk of the system, i.e. programs, documents, and archives, are scanned, so as to identify the maximum number of Trojans that exist on the system. The determining unit 34 determines whether a deep scanning is selected by the user when the pre-scanning unit 30 determines not to perform the full scanning according to the pre-scanning mode.

According to various embodiments, the terminal device may prompt the user to select the deep scanning by using a display mode. When the user selects the deep scanning, the determining unit 34 of the terminal device may determine that the deep scanning is selected by the user. When the user does not select the deep scanning, a quick scanning may be performed by default.

The deep scanning unit 36 performs the deep scanning when the determining unit 34 determines the deep scanning is selected by the user. According to various embodiments, scanning scopes of the deep scanning include system critical locations of the quick scanning, a path backtracking of a system active process and a path backtracking of a software uninstall item. The path backtracking, refers to when an original path is C:\program files\tencent\qq\bin\qq.exe, and the backtracking path is c:\program files\tencent. The above scanning scopes basically cover all locations of program files of the system, so as to avoid scanning a large number of non-program directories and personal file directories, and thus, scanning performance is improved.

The quick scanning unit 38 performs the quick scanning when the determining unit 34 determines the deep scanning is not selected by the user. In the quick scanning, critical system directory files, self-starting register entries, self-starting programs, system memory environment, etc. are scanned and tested to identify conventional popular Trojans.

In the various embodiments of the present disclosure, before the scanning operation is started, the security state of the system is predetermined by using the pre-scanning mode. When the security state is bad, the full scanning is performed to test the Trojans thoroughly. When the security state is good, the quick scanning may be performed to consume few resources, or the deep scanning may be performed to find more hidden Trojans.

Further, in the various embodiments of the present disclosure, before the scanning operation is started, whether to perform the full scanning is determined according to the pre-scanning mode. When the full scanning is not required, the scanning is performed according to the selection of the user. Therefore, the scanning mode is selected intelligently according to the security state of the system on the terminal device, and thus, the scanning efficiency is improved.

FIG. 4 is a diagram illustrating a structure of a pre-scanning unit of a terminal device for scanning files according to various embodiments of the present disclosure. In the various embodiments, the pre-scanning unit includes a selecting module 300, a first determining module 302, a second determining module 304, and a third determining module 306.

The selecting module 300 selects the pre-scanning mode. According to various embodiments, the pre-scanning mode may be selected by a user of the terminal device, or when the user triggers a scanning function, the terminal device performs scanning processing according to the pre-scanning mode by default, and then another scanning mode may be selected.

The first determining module 302 determines whether there is a Trojan characteristic of infecting all programs on a hard disk.

A second determining module 304 determines whether there is a Trojan characteristic indicating a system DLL is hijacked when the first determining module 302 determines there is no Trojan characteristic of infecting all programs on the hard disk. The third determining module 306 determines whether there is a prior characteristic of the full scanning when the second determining module 304 determines that there is no Trojan characteristic indicating the system DLL is hijacked. When the third determining module 306 determines that there is no prior characteristic of the full scanning, it is indicated that the security state of the system on the terminal device is normal after the above three are determined.

It should be noted that an operation sequence of the above three modules is not limited according to various embodiments of the present disclosure. For example, the second determining module 304 may determine whether there is the Trojan characteristic indicating a system DLL is hijacked first; when there is no Trojan characteristic indicating the system DLL is hijacked, the first determining module 302 may determine whether there is the Trojan characteristic of infecting all programs on a hard disk; when there is no Trojan characteristic of infecting all programs on the hard disk, the third determining module 306 may finally determine whether there is the prior characteristic of the full scanning; when there is no prior characteristic of the full scanning, the selecting module determines not to perform the full scanning.

When the first determining module 302 determines that there is the Trojan characteristic of infecting all programs on the hard disk, or when the second determining module 304 determines there is the Trojan characteristic indicating a system DLL is hijacked, or when the third determining module 306 determines there is the prior characteristic of the full scanning, it is indicated that the security state of the system on the terminal device is abnormal, and the full scanning is performed.

By using the technical solutions provided by the various embodiments of the present disclosure, before the scanning operation is started, the security state of the system is predetermined by using the pre-scanning mode. When the security state is bad, the full scanning is performed to test the Trojans thoroughly. When the security state is good, the quick scanning may be performed to consume few resources, or the deep scanning may be performed to find more hidden Trojans.

Further, by using the technical solutions provided by the various embodiments of the present disclosure, before the scanning operation is started, whether to perform the full scanning is determined according to the pre-scanning mode. When the full scanning is not required, the scanning is performed according to the selection of the user. Therefore, the scanning mode is selected intelligently according the security state of the system on the terminal device, and thus, the scanning efficiency is improved.

The methods and modules described herein may be implemented by hardware, machine-readable instructions or a combination of hardware and machine-readable instructions. Machine-readable instructions used in the examples disclosed herein may be stored in storage medium readable by multiple processors, such as a hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD, and specific-purpose computers, and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus, the program codes and the storage medium storing the program codes are part of the technical scheme.

The storage medium for providing the program codes may include a floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM, and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in storage in an extension board inserted in the computer or in storage in an extension unit connected to the computer. In this example, a CPU in the extension board or the extension unit executes at least part of the operations according to the instructions based on the program codes to realize a technical scheme of any of the above examples.

The foregoing are only preferred examples of the present disclosure and are not used to limit the protection scope of the present disclosure. Any modification, equivalent substitution, and improvement without departing from the spirit and principle of the present disclosure are within the protection scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for scanning files, comprising:
determining whether to perform a full scanning according to a pre-scanning mode;
determining whether a deep scanning is selected by a user, when it is determined not to perform the full scanning according to the pre-scanning mode; and
performing the deep scanning, when the deep scanning is selected by the user.

2. The method of claim 1, further comprising:
performing the full scanning, when it is determined to perform the full scanning according to the pre-scanning mode.

3. The method of claim 1, further comprising:
performing a quick scanning, when the deep scanning is not selected by the user.

4. The method of claim 1, wherein determining whether to perform the full scanning according to the pre-scanning mode comprises:
determining whether there is a Trojan characteristic of infecting all programs on a hard disk; and
determining to perform the full scanning, when there is the Trojan characteristic of infecting all programs on the hard disk.

5. The method of claim 1, wherein determining whether to perform the full scanning according to the pre-scanning mode comprises:
determining whether there is a Trojan characteristic indicating a system Dynamic Link Library (DLL) is hijacked;
determining to perform the full scanning, when there is the Trojan characteristic indicating the system DLL is hijacked.

6. The method of claim 1, wherein determining whether to perform the full scanning according to the pre-scanning mode comprises:
determining whether there is prior characteristic of the full scanning;
determining to perform the full scanning, when there is the prior characteristic of the full scanning.

7. The method of claim 1, wherein determining whether to perform the full scanning according to the pre-scanning mode comprises:
determining whether there is a Trojan characteristic of infecting all programs on a hard disk;
determining whether there is a Trojan characteristic indicating a system Dynamic Link Library (DLL) is hijacked;
determining whether there is prior characteristic of the full scanning;
determining not to perform the full scanning, when there is no Trojan characteristic of infecting all programs on the hard disk, and when there is no Trojan characteristic indicating the system DLL is hijacked, and when there is no prior characteristic of the full scan.

8. The method of claim 6, wherein the priori characteristic of full scanning is obtained by using sample collection operations or by receiving information from users.

9. The method of claim 7, wherein the priori characteristic of full scanning is obtained by using sample collection operations or by receiving information from users.

10. The method of claim 1, wherein scanning scopes of the deep scanning comprises system critical locations of the quick scanning, a path backtracking of a system active process and a path backtracking of a software uninstall item.

11. An apparatus for scanning files, comprising a processor for executing instructions stored in a memory, the instructions comprise:
a pre-scanning instruction, to determine whether to perform a full scanning according to a pre-scanning mode;
a determining instruction, to determine whether a deep scanning is selected by a user, when it is determined not to perform the full scanning according to the pre-scanning mode; and
a deep scanning instruction, to perform the deep scanning, when the deep scanning is selected by the user.

12. The apparatus of claim 11, the instructions further comprising:
a full scanning instruction, to perform the full scanning, when it is determined to perform the full scanning according to the pre-scanning mode.

13. The apparatus of claim 11, further comprising:
a quick scanning instruction, to perform a quick scanning, when the deep scanning is not selected by the user.

14. The apparatus of claim 11, wherein the pre-scanning instruction comprising:
a selecting instruction, to select the pre-scanning mode;
a first determining instruction, to determine whether there is a Trojan characteristic of infecting all programs on a hard disk; and determine to perform the full scanning when there is the Trojan characteristic of infecting all programs on the hard disk.

15. The apparatus of claim 11, wherein the pre-scanning instruction comprising:
a selecting instruction, to select the pre-scanning mode;
a second determining instruction, to determine whether there is a Trojan characteristic indicating a system Dynamic Link Library (DLL) is hijacked; and determine to perform the full scanning when there is the Trojan characteristic indicating the system DLL is hijacked.

16. The apparatus of claim 11, wherein the pre-scanning instruction comprising:
a selecting instruction, to select the pre-scanning mode;
a third determining instruction, to determine whether there is prior characteristic of the full scanning; and determine to perform the full scanning when there is the prior characteristic of the full scanning.

17. The apparatus of claim 11, wherein the pre-scanning instruction comprising:
a selecting instruction, to select the pre-scanning mode; determine to perform the full scanning, when there is no Trojan characteristic of infecting all programs on the hard disk and when there is the Trojan characteristic indicating the system DLL is hijacked and when there is the prior characteristic of the full scanning;
a first determining instruction, to determine whether there is a Trojan characteristic of infecting all programs on a hard disk;
a second determining instruction, to determine whether there is a Trojan characteristic indicating a system Dynamic Link Library (DLL) is hijacked;
a third determining instruction, to determine whether there is prior characteristic of the full scanning.

18. The apparatus of claim 16, wherein the priori characteristic of full scanning is obtained by using sample collection operations or by receiving information from users.

19. The apparatus of claim 17, wherein the priori characteristic of full scanning is obtained by using sample collection operations or by receiving information from users.

20. The apparatus of claim 11, wherein scanning scopes of the deep scanning comprises system critical locations of the quick scanning, a path backtracking of a system active process and a path backtracking of a software uninstall item.
